(19) United States
(12) Patent Application Publication
(10) Pub. No.: US 2016/0301582 A1
(43) Pub. Date: Oct. 13, 2016

(54) UTILIZING COLLECTED DATA FROM A SOFTWARE-DEFINED NETWORKING NETWORK TO DIAGNOSE A USER EXPERIENCE

(71) Applicant: HEWLETT-PACKARD ENTERPRISE DEVELOPMENT LP, Houston, TX (US)

(72) Inventors: Manfred R. ARNDT, Roseville, CA (US); James S. HISCOCK, Rockport, MA (US)

(21) Appl. No.: 15/028,476

(22) PCT Filed: Oct. 11, 2013
(86) PCT No.: PCT/US2013/064649

§ 371 Date: Jun. 29, 2016

(51) Int. Cl. H04L 12/26; H04L 29/06

(52) U.S. Cl. CPC H04L 43/04; H04L 43/10; H04L 65/80

(57) ABSTRACT

Utilizing collected data from a software-defined networking (SDN) network to diagnose a user experience includes receiving application session quality metrics from an application within a SDN network, collecting network information from network components that carry network traffic of the SDN network, and utilizing the application session quality metrics and the network information to run a diagnostic analysis to improve the user experience in real-time or for future sessions.

### BACKGROUND

A software-defined networking (SDN) network allows network administrators to orchestrate and automate control of network services, such as network components and applications through abstraction of a lower level functionality. A SDN controller in the SDN network makes decisions about how network traffic is processed by instructing switches within the SDN network to define forwarding behavior of data packets traveling across the SDN network according to polices set by high-level policy or business logic.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for utilizing collected data from a SDN network to diagnose a user experience, according to one example of principles described herein.

FIG. 2 is a diagram of an example of a system for utilizing collected data from a SDN network to diagnose a user experience, according to one example of principles described herein.

FIG. 3 is a flowchart of an example for utilizing collected data from a SDN network to diagnose a user experience, according to one example of principles described herein.

FIG. 4 is a flowchart of an example for utilizing collected data from a SDN network to diagnose a user experience, according to one example of principles described herein.

FIG. 5 is a diagram of an example of a utilizing system, according to one example of principles described herein.

FIG. 6 is a diagram of an example of a utilizing system, according to one example of principles described herein.

Throughout the drawings, identical reference numbers designate similar, but not necessarily identical, elements.

### DETAILED DESCRIPTION

To enhance a user's experience, manual adjustments to the SDN network and an application's parameters are made to adjust for dynamic environment changes from network traffic patterns and loads. Manual adjustments may adjust the SDN network to compensate for topology changes, radio frequency (RF) interference, varying link capacity, congestion, among other dynamic environment changes. Further, manual adjustments may adjust the application's parameters to compensate for packet loss, delay, and jitter.

Although, manual adjustments are used to enhance a user's experience, manual adjustments to the SDN network and application parameters are time consuming, error prone, and are slow to adjust to dynamic environment changes. Manual adjustments use static policies that are used to match application settings with SDN network settings. Further, applications have access to information about the communication from the application's endpoints, such as user devices. For example, an application may have access to a user device's application session characteristics, including N-tuple, networking mean opinion score (NMOS) degradation, delay, jitter, or packet loss values. However, the applications have limited information about the SDN network or individual network devices along the path or physical topology that makes up the SDN network. Additionally, the SDN controller has access to SDN network information such as characteristics about the SDN network or individual devices along the path or physical topology that makes up the SDN network. However, the SDN controllers have limited information about communication from an application's endpoints. Further, the application settings may not react well to dynamic changes in the SDN network. As a result, if application settings are not matched with SDN network settings a user experiences degraded performance on the SDN network.

The principles described herein include a method for utilizing collected data from a SDN network to diagnose a user experience. Such a method includes receiving application session quality metrics from an application within a SDN network, collecting network information from network components that carry network traffic of the SDN network, and utilizing the application session quality metrics and the network information to run a diagnostic analysis. Such a method allows information about the network and information about the application to be combined to make repairs or dynamic adjustments to tune the SDN network and application in a coordinated manner. As a result, the diagnostic analysis may be used to enhance a user's experience on the SDN network.

Further, the method can include recommending repairs to the network components and adjusting policies to the network components based on the diagnostic analysis. More information about recommending repairs and adjusting policies will be described in more detail below.

A session may be a permanent or dynamic exchange of data packets from one user device to another user device. In one example, a session may include a dynamic exchange of data packets for video, audio, desktop sharing, or combinations thereof.

A SDN network may be a combination of hardware and software that includes a SDN controller, a number of switches, routers, wireless access points, and instructions is processed by the switches, routers, and wireless access points to define the forwarding behavior of data packets. Further, the term switch can apply equally to a wide area network (WAN) router, wireless access point, or other SDN networking device. In one example, the SDN controller in the SDN network makes decisions about how network traffic is processed by instructing switches within the SDN network to define the forwarding behavior of data packets traveling across the SDN network.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

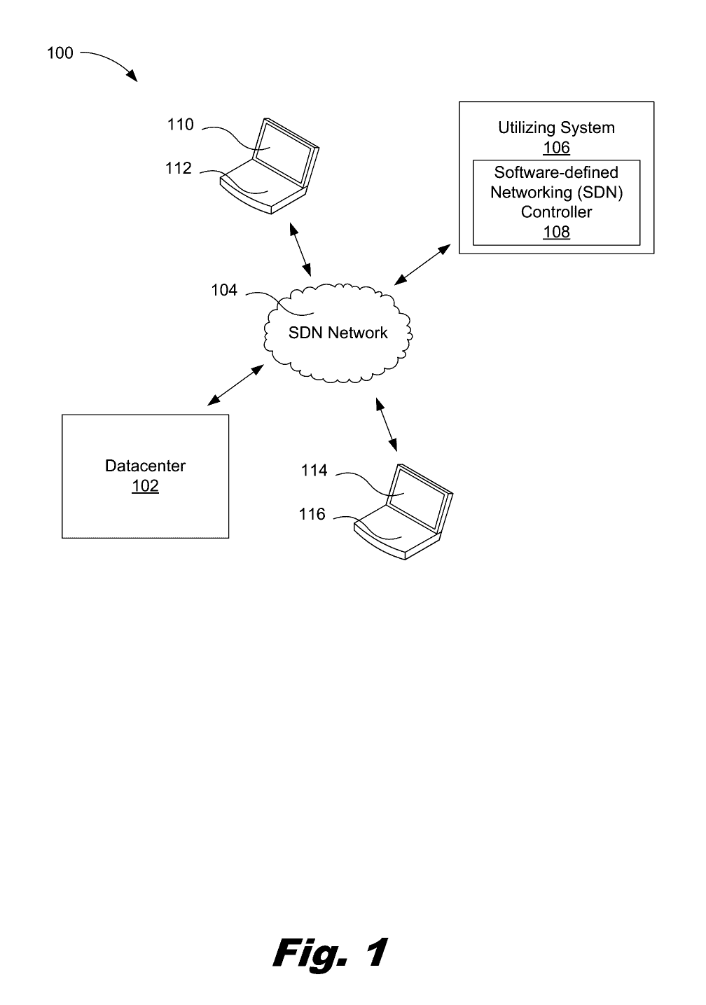

Referring now to the figures, FIG. 1 is a diagram of an example of a system for utilizing collected data from a SDN network to diagnose a user experience, according to one example of principles described herein. As will be described below, a utilizing system is in communication with a SDN network to receive application session quality metrics from an application. Further, the utilizing system collects network information from network components that carry network traffic of the SDN network. Further, the utilizing system utilizes the application session quality metrics and the network information to run a diagnostic analysis.

In one example, the system (100) includes a first user device (112) with a display (110). In this example, a first user uses the first user device (112) to access a SDN network (106). In keeping with the given example, the first user connects with a second user over the SDN network (106). The second user uses a second user device (116) with a display (114) to start a session with the first user. In one example, the first user and second user may exchange data packets during the session over the SDN network (104). In this example, the session may include data packets for instant messaging, video conference calling, audio conference calling, web conferencing, other data packets, or combinations thereof.

The system (100) further includes a datacenter (102). As will be described in other parts of this specification, the datacenter (102) includes an application that allows the first user using the first user device (112) and the second user using the second user device (116) to negotiate parameters and start a session for exchanging data packets over the SDN network (104).

The system (100) further includes a SDN controller (108). As will be described in other parts of this specification, the SDN controller (108) makes decisions about how network traffic is processed by instructing switches within the SDN network to define the forwarding behavior of data packets traveling across the SDN network (104). In one example, the SDN controller (108) has a global view of the SDN network (104). For example, the SDN controller (108) may have a global view of the topology of the SDN network (104), the switches within the SDN network (104), user devices within the SDN network (104), other global views, or combinations thereof. As a result, the SDN controller (108) may forward data packets traveling across the SDN network (104) in an appropriate manner.

The system (100) further includes a utilizing system (106). In keeping with the given example, the utilizing system (106) receives application session quality metrics from an application within a SDN network (104). In one example, the application's services and control may be resident in a datacenter (102). In this example, the first user device (112) and the second user device (116) may access the application services via the SDN network (104). As mentioned above, the application includes application session quality metrics for a session. Further, the application session quality metrics are received by the utilizing system (106) and make available to the SDN controller (108).

Further, the utilizing system (106) collects network information from network components that carry network traffic of the SDN network (104). In one example, the network information from the SDN network (104) includes the topology of the SDN network (104), the switches within the SDN network (104), user devices (112 and 116) within the SDN network (104), other network information, or combinations thereof.

The utilizing system (106) utilizes the application session quality metrics and the network information to run a diagnostic analysis. Based on the diagnostic analysis, the utilizing system (106) recommends repairs to the network components within the SDN network (104). Further, based on the diagnostic analysis, the utilizing system (106) adjusts policies to the network components within the SDN network (104). As a result, the diagnostic analysis may be used to enhance a user's experience on the SDN network. More information about the utilizing system (106) will be described later on in this specification.

While this example has been described with reference to the utilizing system being located outside of the network, the utilizing system may be located in any appropriate location according to the principles described herein. For example, the utilizing system may be located in a user device, a server, in the SDN network or combinations thereof. Further, the utilizing system may receive application session quality metrics during a session, after a session, or combinations thereof.

Further, while this example has been described with reference to the SDN controller being located on a utilizing system, the SDN controller may be located in any appropriate location. For example, the SDN controller may be located in the SDN network, in a datacenter, or combinations thereof. Still further, while this example has been described with reference to the two user devices and one datacenter in the system, in practice the system may include millions of user devices and hundreds of datacenters.

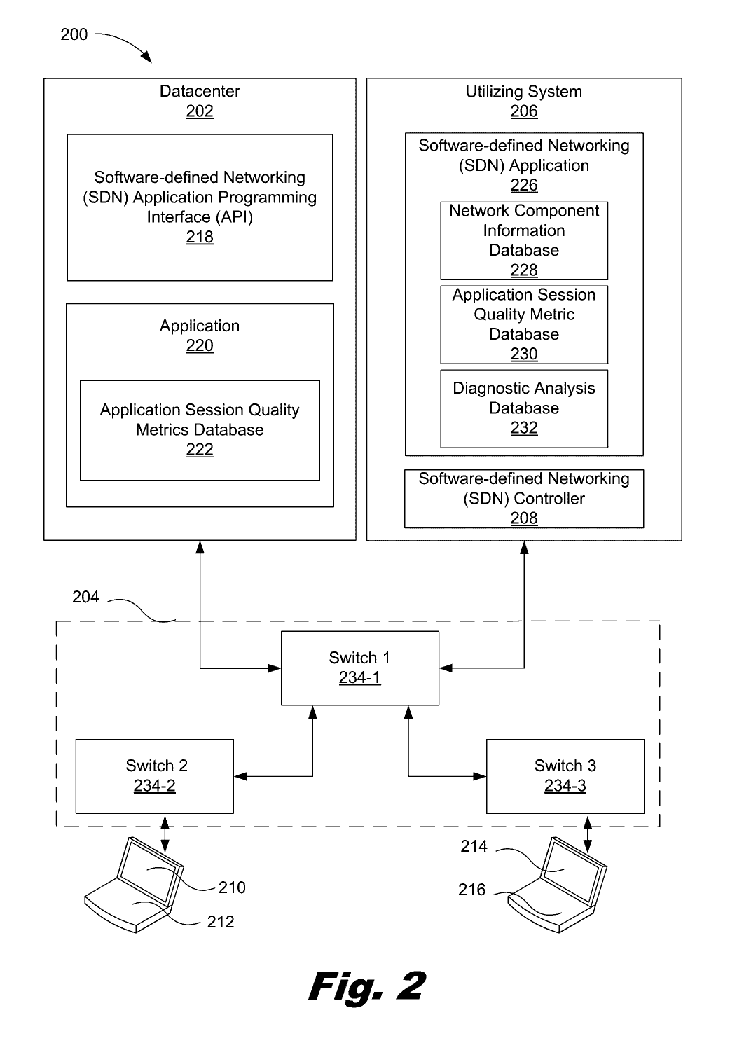

FIG. 2 is a diagram of an example of a system for utilizing collected data from a SDN network to diagnose a user experience, according to one example of principles described herein. As mentioned above, a utilizing system is in communication with a SDN network to receive application session quality metrics from an application. Further, the utilizing system collects network information from network components that carry network traffic of the SDN network. Further, the utilizing system utilizes the application session quality metrics and the network information to run a diagnostic analysis.

In the example of FIG. 2, the system (200) includes a first user device (212) with a display (210). In one example, a first user uses the first user device (212) to access the SDN network (204). In keeping with the given example, the first user connects with a second user over the SDN network (204). In this example, the second user uses a second user device (216) with a display (214) to start a session with the first user. As mentioned above, the first user device (212) and second user device (216) may exchange data packets during the session.

To allow the first user to exchange packet of data with the second user over the SDN network (204) during a session, the SDN controller (208) may instruct the switches (234) to forward a real time transport protocol (RTP) media stream from the first user device (212) to the second user device (216). Further, the RTP media stream may include data packets for a session that includes audio packets, video packets, other data packets, or combinations thereof. In this example, the SDN controller instructs switch 2 (234-2) to forward the RTP media stream from the first user device (212) to switch 1 (234-1). The SDN controller then instructs switch 1 (234-1) to forward the RTP media stream to switch 3 (234-3). Further, the SDN controller then instructs switch 3 (234-3) to forward the RTP media stream to the second user device (216). While this examples has been described with reference to forwarding the RTP media stream from the first user device (212) to the second user device (216), a RTP media stream may also be forwarded from the second user device (216) to the first user device (212).

As mentioned above, the system (200) includes a datacenter (202). The datacenter (202) includes an application (220) that allows the first user using the first user device (212) and the second user using the second user device (216) to establish a session over the SDN network (204). In one example, the application (220) may be a virtual desktop infrastructure (VDI). In this example, the VDI may separate the desktop environment and associated application from the physical user device that is used to access the VDI. In another example, the application (220) may be a gaming application. In this example, the application (220) includes computer program code to allow a first user and a second user to play an interactive game over the SDN network (204). In yet another example, the application (220) may be an application that allows a user to trade stock. In still another example, the application (220) may be an application that is a transactional database.

Further, the application (220) uses the Session Initiation Protocol (SIP) signaling to define the data packets that are being exchanged between the first user device (212) and the second user device (216). In one example, the SIP signaling governs establishment of a connection, termination, and other significant elements of a session between the first user device (212) and the second user device (216).

Additionally, the application (220) collects the application's session quality metrics during a session. In one example, the application's session quality metrics indicate the quality of the session. In one example, application's session quality metrics indicate the quality of the session is poor. In another example, the application's session quality metrics indicate the quality of the session is excellent. In this example, the applications session quality metrics may include NMOS degradation metrics, delay metrics, jitter metrics, packet loss value metrics, or combinations thereof. In one example, the applications session quality metrics may be collected from the application on the user device and stored in an applications session quality metrics database (222). As a result, the application session quality metrics may be used at a later point in time to run a diagnostic to determine a user's experience.

In keeping with the given example, NMOS degradation metrics may provide a numerical indication of the perceived quality from the users' perspective of received media after compression and/or transmission. In one example, the NMOS is expressed as a single number in the range 1 to 5. In this example, 1 is the lowest perceived audio quality, and 5 is the highest perceived audio quality. In this example, the NMOS degradation metrics may be stored in an applications session quality metrics database (222).

As mentioned above, an applications session quality metric may include delay metrics. In this example, the delay metric may include how long a packet of data was in transit across the SDN network from the source, until it reached its intended destination. In one example, if the delay metric indicates the packet of data is reaching its destination later than an acceptable time the delay metric may indicate the session has poor quality. Alternatively, a delay metric may indicate a packet of data was delayed in the SDN network, but the delay could not be avoided. In one example, if the delay metric indicates the packet of data is reaching its destination within an acceptable time, the delay metric may indicate the session has excellent quality. In this example, the delay metrics may be stored in an applications session quality metrics database (222).

As mentioned above, an applications session quality metric may include jitter metrics. In this example, jitter metrics may indicate an undesired deviation from true periodicity of an assumed periodic signal. In one example, jitter can produce undesired degradation effects of the audio media, video media, and loss of transmitted data between network devices. As a result, a jitter metric may indicate if a session has excellent or poor quality. In this example, the jitter metrics may be stored in an applications session quality metrics database (222).

As mentioned above, an applications session quality metric may include packet loss value metrics. In this example, packet loss value metrics may indicate that data packets traveling across a SDN network fail to reach their intended destination. In one example, if the packet loss value metric indicates five percent or more of the data packets are lost, the session has poor quality. Alternatively, if the packet loss value metric indicates less than five percent of the data packets are lost, the session has excellent quality. As a result, a packet loss value metric may indicate the session has excellent or poor quality. In this example, the packet loss value metrics may be stored in an applications session quality metrics database (222).

While the examples above make reference to one of the application session quality metrics being used to determine if a session has poor or excellent quality, any combination of application session quality metrics may be correlated to determine if a session has poor or excellent quality. For example, the applications session quality metrics, such as NMOS degradation metrics, delay metrics, jitter metrics, packet loss value metrics, or combinations thereof, may be correlated to determine if a session has poor quality or excellent quality.

Further, the datacenter (202) may include a SDN application programming interface (API) (218). In one example, the SDN API (218) receives the application's session quality metrics from the applications session quality metrics database (222). In this example, the SDN API (218) sends the application's session quality metrics to the utilizing system (206). In one example, the utilizing system (206) may store the application session quality metrics in an application session quality metrics database (230) on a SDN application (226). As will be described later on in this specification, the application's session quality metrics are received by the SDN controller (208) and used by the diagnostic analysis to further enhance a user's experience.

Further, the utilizing system (206) collects network information from network components that carry network traffic of the SDN network (204). In one example, the network information from SDN network (204) includes the topology of the SDN network (204), the switches (234) within the SDN network (204), user devices (212 and 216) connected to the SDN network (204), network utilization statistics, other network information, or combinations thereof. In this example, the network information that the utilizing system (206) collects, is stored in a network component information database (228). In this example, the network component information database (228) may be located in the SDN application (226).

The utilizing system (206) utilizes the application session quality metrics in the application session quality metrics database (230) and the network information in the network component information database (228) to run a diagnostic analysis. In one example, the diagnostic analysis is stored in a diagnostic analysis database (232). Based on the diagnostic analysis, the utilizing system (206) recommends repairs to the network components within the SDN network (204). Further, based on the diagnostic analysis, the utilizing system (206) adjusts policies to the network components within the SDN network (204). In one example, the policies may include quality of service (QoS) policies, routing policies, policy based routing (PBR), re-route traffic policies, load balance policies, infrastructure assisted roaming function polices, rate-limit offending traffic policies, or combinations thereof.

In one example, the QoS policies include policies that allow the transport of network traffic with special requirements. For example, audio, video, data, or combinations thereof. By adjusting a QoS policy, the user's experience may be enhanced during a session.

In keeping with the given example, a policy may include routing policies or policy based routing. In one example, routing polices are used for routing decisions of data packets based on the routing policy. In one example the routing policy may route data packets based on a destination address. In another example, the routing policies may route data packets based on other criteria, such as a source address, size of the packet of data, the payload protocol, application session information, other criteria, or combinations thereof. By adjusting a routing policy, the user's experience may be enhanced during a session.

As mentioned above, a policy may include re-route traffic policies. In one example, re-route traffic policies are used to re-route data packets based on the re-route traffic policies. In one example, the re-route traffic police may re-route data packets based on a destination address. In another example, the re-route traffic police may re-route data packets to maximize throughput, minimize response time, or avoid overloading a single computing resource or networking link based on other criteria. By adjusting the re-route traffic policies, the user's experience may be enhanced during a session. Further, in one example there may be more than one path based on the destination address. In this example, another path may be chosen to provide better service for a specific application.

In keeping with the given example, a policy may include load balance policies. In one example, load balance policies are used to distribute workloads across multiple networking or computing resources such as servers, network links, disk drives, central processing units, other computing resources, or combinations thereof. Further, load balance polices are used to optimize resource use, maximize throughput, minimize response time, and avoid overloading a single computing resource or networking link. In one example, if a user is experiencing a session with poor quality, a load balance policy may be change such that the user experiences the session with excellent quality.

As mentioned above, a policy may include infrastructure assisted roaming function polices. In one example, infrastructure assisted roaming function polices are used to assist user devices to roam to a more preferable wireless access point, to improve connectivity services based on location, network load, better RF condition, or a variety of other factors. In one example, if a user is experiencing a session with poor quality, an infrastructure assisted roaming function policy may be changed such that the user experiences the session with excellent quality.

In keeping with the given example, a policy may include rate-limit offending traffic policies. In one example, rate-limit offending traffic policies may be used to limit the traffic an SDN network experiences. In this example, if a user is experiencing a session with poor quality due to congestion of the SDN network, a rate-limit offending traffic policy may be changed such that the user experiences the session with excellent quality.

As mentioned above, based on the diagnostic analysis, the utilizing system (206) adjusts policies to the application (220). In one example, the utilizing system (206) can instruct the application (220) to select a different codec type, compression function, Forward Error Correction (FEC), roaming policy, or combinations thereof.

In one example, a codec is used for encoding or decoding data packets. In this example, different types of codecs have different types of lossy properties. If a type of codec is used during a session experiencing a certain level of packet loss, a user may experience a session with poor quality. By instructing the application (220) to select a different codec type, the user may experience a session with excellent quality.

In keeping with the given example, a compression function is used to compress data packets. In one example, if a compression function is used during a session with low compression quality, a user may experience a session with poor quality. By instructing the application (220) to adjust the quality of a compression function to a higher compression quality, the user may experience a session with excellent quality.

In still keeping with the given example, a FEC is used for correcting errors in the transmission of data packets over unreliable networks. In one example, by instructing the application (220) to adjust the FEC, the data packets may be encoded in a redundant manner such that a user may experience a session with excellent quality.

In the example given above, a roaming policy is used to force an application or the user's device to change the wireless roam policies. In one example, if a user is experiencing a session with poor quality, the application (220) may be instructed to change a roaming policy such that the user experiences the session with excellent quality.

Thus the utilizing system (206) adjusts policies to the network components within the SDN network (204) to enhance a user's experience. Further, in one example, the utilizing system (206) makes real-time adjustments during a session to react to application and/or end node runtime adjustments to improve the user experience. In another example, the utilizing system (206) makes adjustments to future sessions to react to application and/or end node runtime adjustments to improve the user experience. For example, as mentioned above, the SDN controller (208) access the databases (228, 230, 232) to make decisions on where and when to send network traffic. For example, the databases (228, 230, 232) may indicate that during most Saturdays from 1:00 pm to 2:00 pm, there is a high number of video sessions. As a result, during Saturdays from 1:00 pm to 2:00 pm, the network may become congested. As a result, the SDN controller (208) may instruct the application to limit the number of video sessions via call admission control or instruct the application to use a higher compression function during that time.

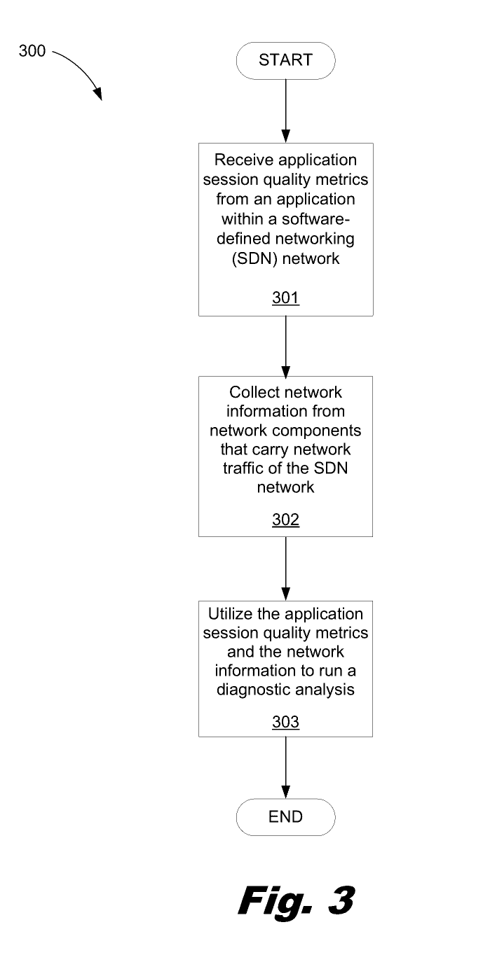

FIG. 3 is a flowchart of an example for utilizing collected data from a SDN network to diagnose a user experience, according to principles described herein. The method (300) for utilizing collected data from a SDN network to diagnose a user experience includes receiving (301) application session quality metrics from an application within a SDN network, collecting (302) network information from network components that carry network traffic of the SDN network, and utilizing (303) the application session quality metrics and the network information to run a diagnostic analysis.

As mentioned above, the method includes receiving (301) application session quality metrics from an application within a SDN network. In one example, an application stores, in memory, the application's session quality metrics. In this example, the application's session quality metrics are stored in an application session quality metrics database.

In one example, the application session quality metrics database may include application session quality metrics such as NMOS degradation metrics, delay metrics, jitter metrics, packet loss values metrics, or combinations thereof. As will be described below, the application session quality metrics are used later on to run a diagnostic analysis.

As mentioned above, the method includes collecting (202) network information from network components that carry network traffic of the SDN network. In one example, the network information that is collected from the network components may include a topology of the SDN network. In this example, the topology of the SDN network includes the topology of servers, the topology of user devices, the topology of switches, the topology of disk drives and databases, the topology of SDN controllers, the topology of applications, other topologies, or combinations thereof. By collecting network information from network components that carry network traffic of the SDN network, the SDN controller has a global view to the topology of SDN network.

In one example, the network information is stored in a network component information database on a SDN application. As will be described below, the network component information is used later on to run a diagnostic analysis.

As mentioned above, the method includes utilizing (303) the application session quality metrics and the network information to run a diagnostic analysis. In one example, utilizing both the application session quality metrics and the network information, the diagnostic analysis allows the SDN controller to orchestrate network traffic to enhance a user's experience.

In one example, the diagnostic analysis may indicate that based on the application session metrics a user is having a poor quality experience. In another example, the diagnostic analysis may indicate that the user is having a poor quality experience due to poor RF conditions or interference. In yet another example, the diagnostic analysis may indicate that the poor session quality is due to SDN network congestion.

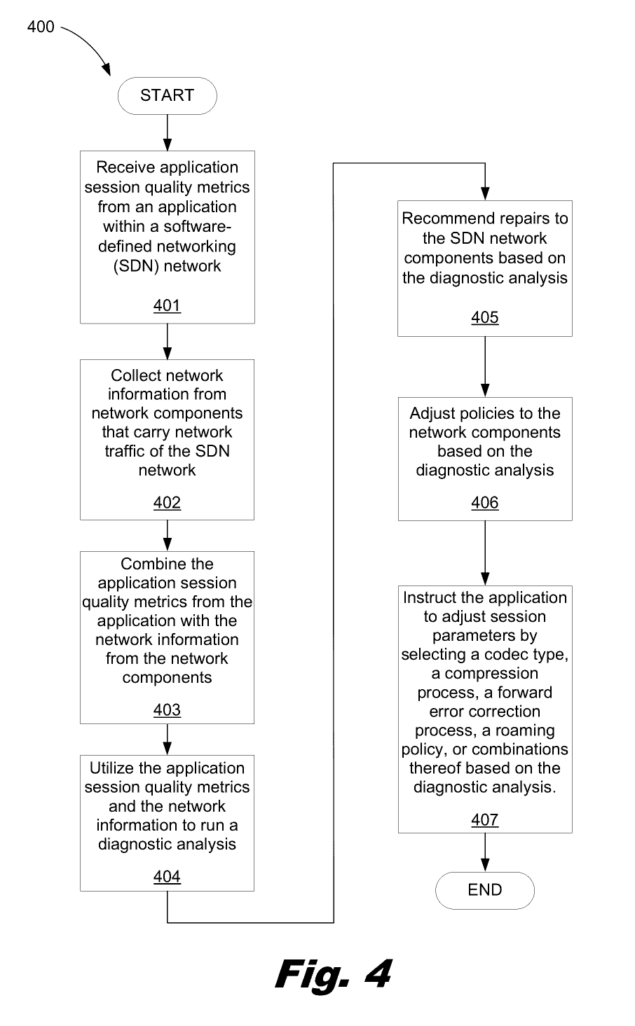

FIG. 4 is a flowchart of an example for utilizing collected data from a SDN network to diagnose a user experience, according to principles described herein. The method (400) for utilizing collected data from a SDN network to diagnose a user experience includes receiving (401) application session quality metrics from an application within a SDN network, collecting (402) network information from network components that carry network traffic of the SDN network, combining (403) the application session quality metrics from the application with the network information from the network components, utilizing (404) the application session quality metrics and the network information to run a diagnostic analysis, recommending (405) repairs to the network components based on the diagnostic analysis, adjusting (406) policies to the network components based on the diagnostic analysis, instructing (407) the application to adjust session parameters by selecting a codec type, a compression process, a forward error correction process, a roaming policy, or combinations thereof based on the diagnostic analysis.

As mentioned above, the method includes combining (403) the application session quality metrics from the application with the network information from the network components. In one example the application session quality metrics and network information are combined such that the combined information includes detailed information of when a poor quality session occurred and where the poor quality session occurred. In this example, the application session quality metrics and the network information are combined at a specified interval of time. For example, the application session quality metrics and the network information are combined every minute. In another example, the application session quality metrics and the network information are combined each time ‘N’ data packets are sent from one user to another user. In yet another example, the application session quality metrics and the network information are combined when an error in the SDN network is detected. For example, if one user device loses connection with the SDN network. As a result, the application session quality metrics and the network information are combined.

As mentioned above, the method includes recommending (405) repairs to the network components based on the diagnostic analysis. In one example, if the application session metrics indicates that a user is having a poor quality experience during a session based on the diagnostic analysis, the SDN controller can correlate the application session quality metrics with the network component information to diagnose the cause of the impairments. In this example, if the issue is due to poor RF conditions or interference, the SDN controller can send information to the SDN API to instruct the SDN API to dynamically switch to a more robust codec type with packet loss concealment (PLC) and/or use FEC to mitigate the impact of packet loss, at the expense of a higher bandwidth usage.

As mentioned above, the method includes adjusting (406) policies to the network components based on the diagnostic analysis. In one example, if the source of the session quality issues is due to SDN network congestion based on the diagnostic analysis, the SDN controller instructs the application to reduce the bandwidth usage by using a lower-bit rate codec. This allows the application and the SDN controller to use the application session quality metrics along with network component information to provide a better coordination between the SDN network and application by dynamically adjusting application session parameters to improve the user experience and/or more efficiently utilize networking resources.

As mentioned above, the method includes instructing (407) the application to adjust session parameters by selecting a codec type, a compression process, a forward error correction process, a roaming policy, or combinations thereof based on the diagnostic analysis. As mentioned above, a codec is used for encoding or decoding data packets. In one example, different types of codecs have different types of lossy properties. If a type of codec is used during a session with lossy properties, a user may experience a session with poor quality. By instructing the application to select a different codec type, the user may experience a session with excellent quality.

Further, a compression function is used to compress data packets. In one example, if a compression function is used during a session with low compression quality, a user may experience a session with poor quality. By instructing the application to adjust the quality of a compression function to a higher compression quality, the user may experience a session with excellent quality.

Still further, a FEC is used for correcting errors in the transmission of data packets over unreliable networks. In one example, by instructing the application to adjust the FEC, the data packets may be encoded in a redundant manner such that a user may experience a session with excellent quality.

Still even further, a roaming policy is used to force an application or the user's device to change the wireless roam policies. In one example, if a user is experiencing a session with poor quality, the application may be instructed to change a roaming policy such that the user experiences the session with excellent quality.

FIG. 5 is a diagram of an example of a utilizing system (500), according to the principles described herein. The utilizing system (500) includes a receiving engine (502), a collecting engine (504), and a utilizing engine (506). In this example, the system (500) also includes a combining engine (508), a recommending engine (510), an adjusting engine (512), and an instructing engine (514). The engines (502, 504, 506, 508, 510, 512, 514) refer to a combination of hardware and program instructions to perform a designated function. Each of the engines (502, 504, 506, 508, 510, 512, 514) may include a processor and memory. The program instructions are stored in the memory and cause the processor to execute the designated function of the engine.

The receiving engine (502) receives application session quality metrics from an application within a SDN network. In one example, the receiving engine receives one application session quality metric from an application within a SDN network. In another example, the receiving engine (502) receives multiple application session quality metrics from an application within a SDN network.

The collecting engine (504) collects network information from network components that carry network traffic of the SDN network. In one example, the network information that is collected from the network components may include a topology of the SDN network. In one example, the topology of the SDN network includes the topology of servers, the topology of user devices, the topology of switches, the topology of disk drives and databases, the topology of SDN controllers, the topology of applications, and combinations thereof.

The utilizing engine (506) utilizes the application session quality metrics and the network information to run a diagnostic analysis. In one example, the utilizing engine (506) utilizes utilizing both the application session quality metrics and the network information. In another example, the utilizing engine (506) utilizes merely the application session quality metrics. In yet another example, the utilizing engine (506) utilizes merely the network information.

The combining engine (508) combines the application session quality metrics from the application with the network information from the network components. In one example the application session quality metrics and network information are combined such that the combined information includes detailed information of when a poor quality session occurred and where the poor quality session occurred.

The recommending engine (510) recommends repairs to the network components based on the diagnostic analysis. In one example, when the application session metrics indicates that a user is having a poor quality experience, the network controller can correlate the application metrics with other network information to diagnose the cause of the impairments.

The adjusting engine (512) adjusts policies to the network components based on the diagnostic analysis. In one example, the policies may include QoS policies, routing policies, PBR, re-route traffic policies, load balance policies, infrastructure assisted roaming function polices, rate-limit offending traffic policies, or combinations thereof.

The instructing engine (514) instructs the application to adjust session parameters. In one example, the instructing engine (514) instructs the application to select a codec type, a compression process, a forward error correction process, a roaming policy, or combinations thereof based on the diagnostic analysis.

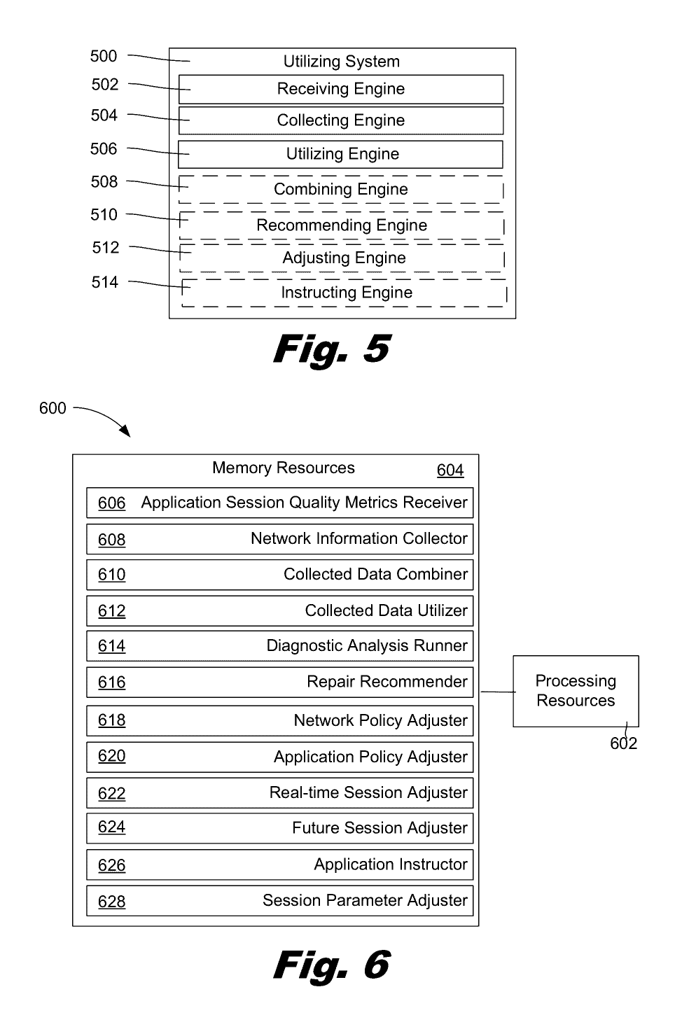

FIG. 6 is a diagram of an example of a utilizing system (600), according to the principles described herein. In this example, the utilizing system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the utilizing system (600). The programmed instructions shown stored in the memory resources (604) include an application session quality metrics receiver (606), a network information collector (608), a collected data combiner (610), a collected data utilizer (612), a diagnostic analysis runner (614), a repair recommender (616), a network policy adjuster (618), an application policy adjuster (620), a real-time session adjuster (622), a future session adjuster (624), an application instructor (626), and a session parameter adjuster (628).

The memory resources (604) include a computer readable storage medium that contains computer readable program code to cause tasks to be executed by the processing resources (602). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The application session quality metrics receiver (606) represents programmed instructions that, when executed, cause the processing resources (602) to receive application session quality metrics from an application. The network information collector (608) represents programmed instructions that, when executed, cause the processing resources (602) to collect network information from an SDN network. The collected data combiner (610) represents programmed instructions that, when executed, cause the processing resources (602) to combine application session quality metrics and network information.

The collected data utilizer (612) represents programmed instructions that, when executed, cause the processing resources (602) to utilize the application session quality metrics and network information in preparation for running a diagnostic analysis. The diagnostic analysis runner (614) represents programmed instructions that, when executed, cause the processing resources (602) to run a diagnostic analysis. The repair recommender (616) represents programmed instructions that, when executed, cause the processing resources (602) to recommend repairs to the network components. The network policy adjuster (618) represents programmed instructions that, when executed, cause the processing resources (602) to adjust polices to the SDN network. The application policy adjuster (620) represents programmed instructions that, when executed, cause the processing resources (602) to adjust polices to an application.

The real-time session adjuster (622) represents programmed instructions that, when executed, cause the processing resources (602) to adjust parameters in real-time during a session. The future session adjuster (624) represents programmed instructions that, when executed, cause the processing resources (602) to adjust parameters after a session to enhance a user's experience for a future session. The application instructor (626) represents programmed instructions that, when executed, cause the processing resources (602) to instruct an application to adjust session parameters by selecting a codec type, a compression process, a forward error correction process, a roaming policy, or combinations thereof based on the diagnostic analysis. The session parameter adjuster (628) represents programmed instructions that, when executed, cause the processing resources (602) to adjust session parameters.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the utilizing system (600) may be implemented on a user device, on a server, on a collection of servers, or combinations thereof.

The utilizing system (600) of FIG. 6 may be part of a general purpose computer. However, in alternative examples, the utilizing system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for utilizing collected data from a software-defined networking (SDN) network to diagnose a user experience, said method comprising:
receiving application session quality metrics from an application within a SDN network;
collecting network information from network components that carry network traffic of said SDN network; and
utilizing said application session quality metrics and said network information to run a diagnostic analysis.

2. The method of claim 1, further comprising recommending repairs to said network components based on said diagnostic analysis.

3. The method of claim 1, further comprising adjusting policies to said network components based on said diagnostic analysis.

4. The method of claim 3, wherein said policies include quality of service (QoS) policies, routing policies, policy based routing (PBR), re-route traffic policies, load balance policies, infrastructure assisted roaming function polices, rate-limit offending traffic policies, or combinations thereof.

5. The method of claim 3, wherein adjusting policies to said network components based on said diagnostic analysis includes adjusting said policies in real-time or adjusting said policies for future sessions to react to said application, an end node, or combinations thereof.

6. The method of claim 1, wherein said application session quality metrics include networking mean opinion scores (NMOS) degradation metrics, delay metrics, jitter metrics, packet loss values metrics, or combinations thereof. 7 The method of claim 1, further comprising instructing said application to adjust session parameters by selecting a codec type, a compression process, a forward error correction process, a roaming policy, or combinations thereof based on said diagnostic analysis.

8. The method of claim 1, wherein utilizing said application session quality metrics and said network information to run said diagnostic analysis further comprises combining said application session quality metrics from said application with said network information from said network components.

9. A system for utilizing collected data from a software-defined networking (SDN) network to diagnose a user experience, said system comprising:
a receiving engine to receive application session quality metrics from an application within a SDN network;
a collecting engine to collect network information from network components that carry network traffic of said SDN network;
a combining engine to combine said application session quality metrics from said application with said network information from said network components;
a utilizing engine to utilize said application session quality metrics and said network information to run a diagnostic analysis; and
an instructing engine to instruct said application to adjust session parameters by selecting a codec type, a compression process, a forward error correction process, a roaming policy, or combinations thereof based on said diagnostic analysis.

10. The system of claim 9, further comprising a recommendation engine to recommending repairs to said network components based on said diagnostic analysis.

11. The system of claim 9, further comprising an adjusting engine to adjust policies to said network components based on said diagnostic analysis.

12. The system of claim 11, wherein said policies include quality of service (QoS) policies, routing policies, policy based routing (PBR), re-route traffic policies, load balance policies, infrastructure assisted roaming function polices, rate-limit offending traffic policies, or combinations thereof.

13. A computer program product for utilizing collected data from a software-defined networking (SDN) network to diagnose a user experience, comprising:
a tangible computer readable storage medium, said tangible computer readable storage medium comprising computer readable program code embodied therewith, said computer readable program code comprising program instructions that, when executed, causes a processor to:
receive application session quality metrics from an application within a SDN network;
collect network information from network components that carry network traffic of said SDN network;
utilize said application session quality metrics and said network information to run a diagnostic analysis; and
recommend repairs to said network components based on said diagnostic analysis.

14. The computer program product of claim 13, further comprising computer readable program code comprising program instructions that, when executed, cause said processor to adjust policies to said network components based on said diagnostic analysis.

15. The computer program product of claim 13, further comprising computer readable program code comprising program instructions that, when executed, cause said processor to instruct said application to adjust session parameters by selecting a codec type, a compression process, a forward error correction process, a roaming policy, or combinations thereof based on said diagnostic analysis.
